(19) United States
(12) Patent Application Publication
(10) Pub. No.: US 2009/0263129 A1
(43) Pub. Date: Oct. 22, 2009

(54) HIGH-SPEED PACKET/ETHERNET DEVICES, METHODS, SYSTEMS AND NETWORKS INCORPORATING TUNABLE PLUGGABLE OPTICS FOR PACKET SWITCHING AND ROUTING FUNCTIONS, AND INCORPORATING GMPS AS THE CONTROL PLANE

(75) Inventors: Zeev Draer, Chatsworth, CA (US); Edna Gannon, Chatsworth, CA (US); Chen Gennossar, Chatsworth, CA (US); Guy Avidan, Chatsworth, CA (US)

Correspondence Address: GARY L. SHAFFER, 901 BANKS PLACE, ALEXANDRIA, VA, 22312, US

(73) Assignee: MRV Communications, Inc., Chatsworth, CA (US)

(21) Appl. No.: 12/426,148

(22) Filed: Apr. 17, 2009

Related U.S. Application Data
(60) Provisional application No. 61/124,620, filed on Apr. 18, 2008.

(51) Int. Cl. H04J 14/02

(52) U.S. Cl. 398/51

(57) ABSTRACT

Devices, systems software, hardware, apparatus, networks, methods and combinations thereof for providing high speed, high capacity digital transmission over fiber-optic communications networks and systems are provided. The invention is particularly effective and useful in Ethernet systems and other communications networks. The photonic systems of the invention are adapted and arranged to be providable as standalone all-optical platforms that are independent of the terminal or services equipment, and that interface directly with the WDM interfaces of service platforms. Utilizing one or a plurality of tunable lasers, the systems, devices, software, hardware and networks of the invention can be adapted and arranged for monitoring, managing and reconfiguring many aspects of communications networks. Photonic systems of the invention can integrate into a single product, such as a router or other switching device, multiple functions. These functions can be integrated to cost-effectively connect sites within extant or new converged multi-service optical networks. Advantageously, all the key transport network functionalities, such as amplification, dispersion compensation, performance monitoring, multiplexing, signal conditioning, wavelength management, and optical add/drop capabilities required for efficient and dependable fiber-optic communications, are efficiently provided by the invention. Ongoing reconfiguration and integration of the functions of the control plane and data plane and their mapping to one another by means of an automated control plane, advantageously increases the reliability and efficiency of ongoing operation and maintenance of optic fiber systems in commercial and other environments.

### PRIORITY STATEMENT

Applicant hereby claims priority to U.S. Provisional Patent Application Ser. No. 61/124,620, filed 18 Apr., 2008, and entitled Packet/Ethernet Device That Incorporates Tunable Pluggable Optics (Standards MSA), Packet Switching and Routing, and GMPS as Control Plane. All the materials and information comprising the disclosure provided in the above-identified Provisional Patent Application are hereby incorporated by reference.

### FIELD OF THE INVENTION

The present invention relates to apparatus, software, hardware, devices, systems, methods and combinations thereof for providing high speed, high capacity digital transmission over fiber-optic communication systems. The invention is particularly effective and useful in Ethernet systems and other communications networks comprising one or more optical fibers.

### BACKGROUND OF THE INVENTION

There are many different types of networks and network systems for sharing files and resources or for otherwise enabling communication between two or more computers. Networks may be categorized based on various features and functions, such as message capacity, range over which the nodes are distributed, node or computer types, node relationships, topology or logical and/or physical layout, architecture based on cable type and data packet format, access possibilities, etc. For example, the range of a network refers to the distance over which the nodes are distributed, such as local-area networks (LANs) within an office or floor of a building, wide-area networks (WANs) spanning across a college campus, or a city or a state, Metro Carrier Networks, global-area networks (GANs) or Core Networks spanning across national boundaries, etc. U.S. Pat. No. 6,363,432 to Laber, U.S. Pat. No. 5,426,637 to Derby, and U.S. Pat. No. 5,923,654 to Schnell all provide some background related to the appropriate art and are hereby incorporated by reference in their entireties.

The architecture of a network generally refers to the cabling or media and media access used as well as the packet structure of the data transmitted across the media. Various architectures are common, including Ethernet using coaxial, twisted pair or fiber-optic cables for operation at different speeds, such as 10 megabits per second (Mbps), (e.g., 10Base-T, 10Base-F, or fast Ethernet operating at 100 Mbps (e.g. 100Base-T, 100Base-FX) 1-Gigabits per second, 100 Gigabits per second or at various other speeds. ARCnet (Attached Resource Computer Network) is a relatively inexpensive network architecture using coaxial, twisted pair or fiber-optic cables for operation at 2.5 Mbps. Token Ring topologies use special IBM cable or fiber-optic cable for operation between 1-16 Mbps. Of course, many other types of networks are known and available.

Each network generally includes two or more computers, often referred to as nodes or stations, which are coupled together through selected media and various other network devices for relaying, transmitting, repeating, translating, providing access for, and filtering, etc., the data between the nodes. The term “network device” generally refers to the computers and their network interface cards (NICs) as well as various other devices on the network, such as repeaters, bridges, switches, routers, access devices and brouters, to name a few examples.

In many conventional systems, a network segment is a group of stations that share the same data-link layer using the same data-link layer protocol. The data-link layer is the next layer above the lowest layer of the Open Systems Interconnection (OSI) Reference Model, where the lowest layer is referred to as the physical layer (PHY). Ownership of the data-link layer is established in accordance with the protocol, but only one station owns the data-link layer at a time. A network operating according to a given communications protocol may be expanded by using one or more repeaters.

A repeater is a hardware device that functions at the physical layer and is used to connect two or more stations of the same network. In particular, a repeater receives packets or data from a data device in one station and re-transmits the packets to another station. Network repeaters support a network segment, but allow a star-wired topology to appear as a single segment. One particular disadvantage of repeaters is that they generate a significant amount of extraneous data traffic, since every data packet is repeated to every other device even though a packet may only be intended for one data device.

A bridge is a hardware device that passes packets from one network segment to another. Conventional bridges also operate at the data-link layer of the OSI Reference Model and allow several segments to appear as a single segment to higher level protocols or programs. A bridge serves both as a medium (the bridge part) and as a filter by dropping packets that need not be relayed to other segments. In particular, a bridge provides packet filtering functions that reduce the amount of unnecessary packet propagation on each network segment. For example, a two-port bridge allows connectivity between two separate network segments. If the packet source and destination are on the same network segment, propagation to another segment is avoided, thereby increasing availability of the segment to attached stations. A multi-port bridge extends the two-port bridge to support a greater number of segments.

The networking industry generally uses the terms “bridge” and “switch” interchangeably, since, externally, they perform the same or very similar functions. For example, a switch is similar in function to a multi-port bridge. However, a distinction is made based upon whether a packet passes through a common data path between data ports, which is the case for a bridge, or whether the packet passes through independent, concurrent data paths, referred to as a switch fabric or simply “switches”, which is the case for a switch. A bridge interfaces each port to a common processor bus and performs store and forward operations. In particular, a processor receives a packet from one port via a common bus, determines the destination node or station, and re-transmits the packet to the port associated with the destination node via the common bus. In contrast, a switch interfaces each port to a switch fabric, where each port has an independent data channel to the switch fabric.

A switch often can replicate multicast or broadcast packets to several other ports, where such replication is typically performed in the switch fabric. In one approach, the switch fabric simultaneously connects an input port to several output ports. In another approach, the switch fabric establishes a connection to each output port, one at a time, and then sends the packet to the connected output port. Such sequential operation adds significant complexity to the switch fabric. Furthermore, multiple broadcast packets received at about the same time often cause bottlenecks and dropped packets.

The optical fiber communications industry has co-evolved along with many industry standards. For example, the IEEE 802.3 standard is often referred to as Ethernet. This standard allows network devices of various manufacturers, such as network interface cards (NICs), hubs, bridges, routers, and switches, to communicate packetized data with each other in different network topologies, such as in local area networks (LANs). The IEEE 802.3 standard is defined in terms of the Open Systems Interconnection (OSI) reference model.

This model defines a data communication system in terms of layers. Among the layers included in the OSI model are: (1) the physical layer (PHY), which specifies the electrical and coding characteristics of the transmission medium; (2) the medium access control (MAC) layer, which controls flow of data through the network; and (3) the network layer, which sets up connections between sources and destinations for data communicated in the network. Other layers include the transport layer, which is a protocol stack for transporting the data, and the application layer, such as a word-processor or spread sheet application.

A supplement to the 802.3 standard, for higher data transmission rates, pertains to higher and higher communications speeds. This standard includes several physical layer (PHY) specifications, for example, for communications over one or more fibers, UTP and coax. Each of these PHY specifications has its own advantages and disadvantages.

The 802.3u standard also includes a specification for a Medium-Independent Interface (MII) between the physical layer (PHY) and the medium access control (MAC) layer. Thus, a bridge for an Ethernet-based network can include different transceivers for the different PHY layers, each of which communicates with a MAC layer of the bridge according to the MII specification. Ethernet includes the capability for simultaneous communication in two directions (full-duplex).

A key technological problem in optical fiber based digital communications systems relates to the limitations attributable to the conventional relationship between optical service mapping and other layers and elements of optical-fiber-based communications equipment, networks and systems. With the recent availability of tunable lasers, and especially those with pluggable capabilities, it has become possible to manage the various wavelength-related functions, as well as other functions, in optical communication systems.

Moreover, with the present invention, it is now possible to bridge various layers in the OSI protocol in efficient and cost-effective ways. In addition, the present invention enables the aggregation of functions from previously separated layers, into one new combined layer, or into a new layer, the “◯” layer.

### SUMMARY OF THE INVENTION

Accordingly, it is an object of the present invention to remedy the drawbacks of such conventional systems by providing devices, methods, systems, software, networks and combinations thereof adapted and arranged for minimizing or eliminating these disadvantages.

Another object of the present invention is to provide methods and systems for providing reliable high-speed digital transmission over one or more optical fibers that can be managed remotely and immediately to fulfill the commercial goals of the users of such systems and networks.

Yet another object of the invention is to provide ways of utilizing tunable pluggable lasers to bridge and consolidate the functions of various communications layers to provide reliable high-speed digital transmission in many different kinds of systems.

In accordance with these and other objects of the invention, an apparatus for improving the speed and management characteristics of a fiber-optic communications network, the apparatus comprising at least one packet switching device, and at least one tunable laser, wherein the at least one tunable laser is adapted and arranged for communications over a fiber-optic system, and wherein the packet switching device and the at least one tunable laser have an operative connection to one another such that an automated control plane is provided. Preferably in some embodiments of the invention, operative connection between the at least one tunable laser and the at least one packet switching device is facilitated by software means.

In one aspect of the invention, the automated control plane is adapted and arranged to perform as a GMPLS plane. In another aspect, the automated control plane is adapted and arranged for mapping the data plane to the at least one tunable laser, and the automated control plane is adapted and arranged for mapping the data plane to a plurality of tunable lasers. As one key advantage of the invention, the automated control plane is adapted and arranged to perform a multiplicity of functions with respect to configuring and re-configuring the apparatus for traffic engineering and the mapping of any flow to connection-oriented tunable optical paths.

In another key advantage, the automated control plane can be adapted and arranged to provide one or more of the functions from the list comprising: effecting and revising policy rules on an ongoing basis, classifying and re-classifying traffic, setting and re-setting traffic engineering and control parameters, data parsing, and flow filtering via blocking or other rules on specified wavelengths. The automated control plane may also be adapted and arranged to provide one or more of the functions from the list comprising: managing the logical flow, operations, administration and management ((OAM) functions performed in the control plane in one or more of the flows of a plurality of OSI layers including providing, revising and implementing automated policy rules in the control plane. The present apparatus, device, system, network and methods are applicable to provide manageable cross connections and other communications between various protocol layers, for example, wherein the layers are OSI layers, and are one or more of OSI layer 1, layer 2, layer 3 and layer 4.

In another advantageous aspect, the at least one tunable laser is adapted and arranged to be managed remotely as well as on an automated basis, and is adapted and arranged to function within one or more communications networks, as well as to be reversibly installable as one or more components of one or more communications networks.

Superior efficiencies and capabilities of an apparatus or device of the invention are exemplified in that it can be adapted and arranged for effecting and managing all the key transport functionalities, including amplification, dispersion compensation, performance monitoring, multiplexing, signal conditioning, wavelength “color” management, and optical add/drop capabilities.

Additional positive characteristics pertain to the software aspects and modules of the invention. Examples of this include wherein the software means for operatively connecting the tunable laser and packet switching device is adapted and arranged to provide any capabilities necessary in order to perform the desired functions. As an example, some software modules of the invention include those which are adapted and arranged to effect measurements of the performance parameters of any system in which they are utilized. In some preferred embodiments, the invention can thereby take measurements at the “◯” unified or converged layer to detect the possible degradation in any network transmission and can trigger alarms or other feedback signals to other elements of the system, for example, to remote network monitoring software. Similarly, the setting of alarms and of correlating or correlated actions can be defined based on the software of the system, and on the control plane and other policies that the software sets, monitors and manages.

The invention may further comprise software means for configuring and re-configuring one or a plurality of tunable lasers within or connected to the apparatus, or within or connected to a network utilizing the apparatus. In addition, the software means comprises one or more software modules for effecting the functions of the apparatus, including software means for operatively connecting the at least one tunable laser to a network such that OAM functions can be managed remotely, software means for cross-connecting various OSI layers to one another, software means for effecting policy rule changes, software means which perform the classification of traffic with respect to headers in various protocol layers (L 2-3-4 headers) with policy rules assignment to virtual flow that are mapped to tunable optics.

The present invention includes also methods for using and configuring the various elements, apparatus, devices and networks of the invention. As an example, the invention includes a method for increasing the speed and management characteristics of a fiber-optic communications network comprising the steps of: providing an apparatus for improving the speed and management characteristics of a fiber-optic communications network, the apparatus comprising at least one packet switching device, and at least one tunable laser, wherein the at least one tunable laser is adapted and arranged for communications over a fiber-optic system, and wherein the packet switching device and the at least one tunable laser have an operative connection to one another such that an automated control plane is provided.

A method of the invention may further include wherein the operative connection is facilitated by software means, wherein at least one of the functions combined from the control plane is the optical service mapping function and wherein at least some of the operational functions are effected by at least one tunable laser.

### DETAILED DESCRIPTION OF THE INVENTION

The present methods and systems of the invention are directed toward increasing the speed, applicability and dependability of digital data transfer in one or more networks.

Before the present invention, the optical service mapping functions in such systems could not be forwarded based on information carried inside the packet or cell headers. Because of this limitation, the transmission of optical service mapping in conventional systems required intermediate equipment. Such technological barriers thus required separate functional devices, layers or elements that performed necessary tasks in tandem rather than being under a unified control system. These conventional systems are less efficient than the present invention and can also be unwieldy to manage.

In one key aspect, the present invention provides an optical packet switching/routing device or system which performs the classification of traffic (L 2-3-4 headers) with policy rules assignment to virtual flow that are mapped to tunable optics. A multiplicity of functions for traffic engineering can be set by an automated control plane of the invention and mapping of any flow to connection-oriented tunable optical paths can be accomplished.

As another key aspect, filtering functions of the invention can be set to block one or more specified paths, such as the physical wavelength or logical VLAN/VC, and act as a multi-layer cross-connect gateway that processes, adds, drops, effects pass-throughs and adjusts to the policy-based service.

In yet another key advantage of the present devices, methods, systems, software, networks and combinations thereof, by the combination or convergence of A) the automated control plane (such as a Generalized MPLS), and 2) the reconfigurable data plane (packet-aware and tunable lasers), the present invention can dramatically reduce the operational load of a network. Additional advantages of the invention include the performance of the auto-discovery of network topologies, advertising resources availability, and the establishment and maintenance of protected and traffic-engineered optical paths with an integrated or holistic view of the service from the physical layer up to the service layer. The present invention thus enables the establishment of an intelligent, well managed, and unified end-to-end deterministic SLA from Access to Metro and regional optical packet transport networks.

GMPLS, as a control plane protocol, is a proposed IETF standard designed to simplify the creation and management of IP/MPLS services over optical networks. The standard would create a single control plane that extends from IP at Layer 3 right down to the optical transport level at Layer 1. Since service providers first began transporting IP traffic, an extremely complex, multilayered overlay architecture has evolved to do the job of carrying IP traffic over networks that were originally designed to support voice and fixed circuits technology. Until the present invention, with the rapid growth of IP traffic promoted by the rapid increase in broadband access, new applications, and new services, these conventional complex overlay networks could not support rapid service provisioning, dynamic bandwidth management, and flexible service creation to meet user demand. With the present invention all of these aspects of communications networks can be supported or improved.

As yet an additional advantage of the present invention, it creates an entire new class of auto-reconfigurable packet transport networks possessing high efficiencies, high dependability and superior management characteristics. As an example, in one key set of embodiments of the invention, the invention provides platforms adapted and arranged to integrate tunable photonics, such as lasers, using standard (MSA) pluggable optics, packet multiplexing, connection-oriented service mapping of packet-to-label and packet-to-lambda in a single converged small, and affordable, form factor 2RU device.

By convergence of the functions of the automated control plane (such as Generalized MPLS) and the reconfigurable data plane (Multi-degree OEO-Switched ROADM), switching devices of platforms of the present invention dramatically reduce the level of necessary network operations; perform auto-discovery of network topologies, advertise resource availability, and are adaptable and arrangable to establish and maintain protected and traffic-engineered optical paths with a holistic view of the service from the physical layer up to the service layer. The invention thus provides a significant extension of metrics to establish intelligent and deterministic SLA's with respect to virtually any optical packet transport network.

As yet another advantage of the invention, it provides the relevant industry for the first time with products and systems that can utilize standard tunable pluggable optics, packet switching and automated control plan (such as GMPLS) to define a new communication layer. Combining key functions of the data plane with those of the control plane to create this new layer, Layer 0—the Wavelength Layer, creates a platform for an entire class of aggregation devices that incorporate or integrate one or more of the photonic layer, the physical layer, the data-link layer and the network layer. The ability to use existing tunable XFPs is an additional innovative element of the methods, devices and systems of the invention.

Examples of additional key features of the invention include: WDM transport and wavelength switching—multi-degree ROADM; advanced provisioning & management for packet-to-lambdas; any packet, any flow and any layer 1 routes mapping; the utilization or integration of a plurality of tunable lasers (example: 4 tunable lasers for 10 G DWDM wavelength services; the utilization or integration of a plurality of predefined lasers (example: 24 predefined lasers) for high-speed rates of 1 Gbps or 2.5 Gbps; built-in 3R function for increased and optimized distance reach; service classification and connection-oriented mapping; the enablement of any-to-any service stitching and comprehensive mesh topology; carrier-class operations, administration and maintenance (OAM); multi-layer end-to-end service OAM, including the latest industry standard like IEEE802.1ag, ITU-T Y.1731, advanced fiber performance monitoring; and it provides a class of small form factor 2RU's with outstanding price-performance ratios.

In yet another significant aspect, the present invention possesses almost universal applicability in the context of the various Multi-Sourcing Agreements (MSA's) and appropriate IEEE standards currently extant in the fiber-optic communications field. These Multi-Sourcing Agreements include, as examples, the GBIC MSA which provides a common specification for systems manufacturers, system integrators, and suppliers of pluggable Gigabit Interface Converters, and the SFF Multi-Source Agreement, which establishes internationally compatible sources of fiber optic transceiver modules in support of standards for fiber optic systems including Asynchronous Transfer Mode (ATM), FDDI, Fibre Channel, Fast Ethernet and Gigabit Ethernet, and Synchronous Optical Network/Synchronous Digital Hierarchy (SONET/SDH) applications.

The present apparatus, software, hardware, devices, systems, networks, methods and combinations thereof are also fully integratable in accordance with the XFP Multi-Source Agreement, which provides specifications for modules, cage hardware, and IC interfaces for 10 Gbit hot pluggable modules adapted for converting serial electrical signals to external serial optical or electrical signals. As a further positive aspect, the present invention is adaptable to comply with the XENPAK Multisource Agreement (XENPAK/X2 MSA), frequently promoted by Agilent Technologies and Agere Systems, that defines a fiber-optic transceiver module which conforms to the 10 Gigabit Ethernet (10 GbE) standard as put forth by IEEE 802.3ae.

Additional examples of the wide applicability of the present invention include its suitability for use in accordance with the SFP Multi-Source Agreement, which establishes internationally compatible sources for pluggable fiber optic transceiver modules in support of standards for fiber optic systems including Asynchronous Transfer Mode (ATM), FDDI, Fibre Channel, Fast Ethernet and Gigabit Ethernet, and SONET/SDH applications, as well as the DWDM Pluggable Transceiver MSA that establishes standard specifications of uniformity for DWDM transceiver package outlines, pin function definitions, optical interface, electrical interfaces and other relevant characteristics, and the SFF Multi-Source Committee, which promulgates storage industry specification requirements relating to many aspects of fixed and removable storage, including optics.

In another key aspect of the devices of the present invention, software means, or combinations of hardware and software means, are used to facilitate many of their critical functions. For example, the invention includes software means for accomplishing, in combination with switches and other hardware, all of the desired functions and capabilities of the invention.

In one key overall characteristic, the present systems, software, methods, devices, hardware and software have application in ensuring that failures in networked computers or other devices or systems can be attenuated resolved or immediately.

Although the present invention and its advantages in the field have been described in detail, those of ordinary skill in the art will understand that various changes, substitutions, alterations and adaptations can be made herein without departing from the scope and spirit of the invention as defined by the following claims and elsewhere herein.

What is claimed is:

1. An apparatus for improving the speed and management characteristics of a fiber-optic communications network comprising
A) at least one packet switching device, and
B) at least one tunable laser,
wherein the at least one tunable laser is adapted and arranged for communications over a fiber-optic system, and
wherein the packet switching device and the at least one tunable laser have an operative connection to one another such that an automated control plane is provided.

2. The apparatus of claim 1, wherein the operative connection is facilitated by software means.

3. The apparatus of claim 1, wherein the automated control plane is adapted and arranged to perform as a GMPLS plane.

4. The apparatus of claim 1, wherein the automated control plane is adapted and arranged for mapping the data plane to the at least one tunable laser.

5. The apparatus of claim 1, wherein the automated control plane is adapted and arranged for mapping the data plane to a plurality of tunable lasers.

6. The apparatus of claim 1, wherein the automated control plane is adapted and arranged to perform a multiplicity of functions with respect to configuring and re-configuring the apparatus for traffic engineering and the mapping of any flow to connection-oriented tunable optical paths.

7. The apparatus of claim 1, wherein the automated control plane is adapted and arranged to provide one or more of the functions from the list comprising: effecting and revising policy rules on an ongoing basis, classifying and re-classifying traffic, setting and re-setting traffic engineering and control parameters, data parsing, and flow filtering via blocking or other rules on specified wavelengths.

8. The apparatus of claim 1, wherein the automated control plane is adapted and arranged to provide one or more of the functions from the list comprising: managing the logical flow, operations, administration and management (OAM) functions performed in the control plane in one or more of the flows of a plurality of OSI layers including providing, revising and implementing automated policy rules in the control plane.

9. The apparatus of claim 8, wherein the OSI layers are one or more of layer 1, layer 2, layer 3 and layer 4.

10. The apparatus of claim 1, wherein the at least one tunable laser is adapted and arranged to be managed remotely as well as on an automated basis.

11. The apparatus of claim 1, adapted and arranged to function within one or more communications networks.

12. The apparatus of claim 1, adapted and arranged to be reversibly installable as one or more components of one or more communications networks.

13. The apparatus of claim 1, adapted and arranged for effecting and managing all the key transport functionalities, including amplification, dispersion compensation, performance monitoring, multiplexing, signal conditioning, wavelength “color” management, and optical add/drop capabilities.

14. The apparatus of claim 1, wherein the software means for operatively connecting the tunable laser and packet switching device to one another is adapted and arranged to provide one or more of performing or effecting measurements of the performance parameters of any system in which they are utilized, taking measurements at the “◯” unified or converged layer to detect the possible degradation in any network transmission, triggering alarms or other feedback signals to other elements of the system in accordance with the measurements taken, reporting the measurements taken to remote network monitoring software or other elements of the system, setting alarms and correlating actions in response to those alarms and in accordance with definitions and policies based on the software of the system, and on the control plane and other policies that the software sets, monitors and manages.

15 The apparatus of claim 1, further comprising software means for configuring and re-configuring one or a plurality of tunable lasers within or connected to the apparatus, or within or connected to a network utilizing the apparatus.

16. The apparatus of claim 1, wherein the software means comprises one or more software modules for effecting the functions of the apparatus, including software means for operatively connecting the at least one tunable laser to a network such that OAM functions can be managed remotely, software means for cross-connecting various OSI layers to one another, software means for effecting policy rule changes, software means which perform the classification of traffic with respect to headers in various protocol layers (L 2-3-4 headers) with policy rules assignment to virtual flow that are mapped to tunable optics.

17. A method for increasing the speed and management characteristics of a fiber-optic communications network comprising the steps of:
I) providing an apparatus for improving the speed and management characteristics of a fiber-optic communications network, the apparatus comprising
A) at least one packet switching device, and B) at least one tunable laser,
wherein the at least one tunable laser is adapted and arranged for communications over a fiber-optic system, and wherein the packet switching device and the at least one tunable laser have an operative connection to one another such that an automated control plane is provided.

18. The method of claim 1, wherein the operative connection is facilitated by software means.

19. The method of claim 1, wherein at least one of the functions combined from the control plane is the optical service mapping function.

20. The method of claim 2, wherein at least some of the operational functions are effected by at least one tunable laser.
